(19) United States
(12) Patent Application Publication
(10) Pub. No.: US 2024/0174085 A1
(43) Pub. Date: May 30, 2024

(54) METHOD AND DEVICE FOR INFLUENCING AN OPTICAL OUTPUT OF IMAGE DATA ON AN OUTPUT DEVICE IN A VEHICLE

(71) Applicant: MERCEDES-BENZ GROUP AG, Stuttgart (DE)

(72) Inventors: Manuel BÖHM, Holzgerlingen (DE); Gerd GULDE, Ammerbuch (DE); Carolin HERRIGEL, Stuttgart (DE); Helmut SCHITTENHELM, Stuttgart (DE); Christian SCHMITT, Neuhausen (DE)

(21) Appl. No.: 18/283,512

(22) PCT Filed: Feb. 28, 2022
(86) PCT No.: PCT/EP2022/054968

§ 371 Date: Sep. 22, 2023

(30) Foreign Application Priority Data
Mar. 23, 2021 (DE) 10 2021 001 515.0

(51) Int. Cl. B60K 35/28; B60K 35/22; G06F 3/01

(52) U.S. Cl. CPC B60K 35/28; B60K 35/22; G06F 3/013; B60K 2360/149

(57) ABSTRACT

A method and a system for influencing optical output of image data on an output device in a vehicle based on a determined gaze direction of a driver. If the gaze direction is directed at the output device, the output image data is faded-out at an average fade-out rate DOWN, which decreases the optical perceptibility of the output image data over time. If the gaze direction is directed at the output device and is directed away from the output device, the optical output of the image data is faded-in at an average fade-in rate UP, which increases the optical perceptibility of the output image data over time. If the gaze direction is directed at the output device again within a pre-determined interval of time relative to the start of the fade-out process, the fade-out is performed at an increased fade-out rate DOWN1 relative to a fade-out rate DOWN.

### BACKGROUND AND SUMMARY OF THE INVENTION

Exemplary embodiments of the invention relate to a method and a device for influencing an optical output of image data on an optical output device in a vehicle, in particular in a motor vehicle, and to a vehicle having such a device.

The reproduction of image data, in particular of moving images, such as: videos, animations, clips etc. on optical output devices that can be seen by the driver of the vehicle is not permitted in numerous countries for safety reasons during the operation of the vehicle due to the high potential for distraction of the respective driver.

Nevertheless, to enable the reproduction of image data by such an output device for a front-seat passenger sitting next to the driver, for example, a method and a device for influencing the attention of a driver of a motor vehicle is known, for example, from the document DE 102019002403 A1, the vehicle comprising a system having an optical output device.

In the method, when a gaze direction of a driver of a vehicle has been determined, image data having a pre-determined fade-out rate DOWN is faded out on an output device. The information output on the output device is thus increasingly less noticeable for the driver and the front-seat passenger, such that the driver is prompted to turn their attention away from the user interface, and thus back to the road. Then, as soon as the gaze direction of the driver is directed away from the output device again, the image data is shown again according to a pre-determined fade-in rate UP.

Exemplary embodiments of the invention, in contrast, are directed to the method or the device such that traffic safety is further increased.

In the method according to the invention, if the gaze direction is directed at the output device again within a pre-determined interval of time in relation to the start of the fade-in process, the fade-out is carried out at an increased average fade-out rate DOWN1 in relation to an average fade-out rate DOWN. Thus, in order to prevent the driver from perceiving the image data displayed on the output device preferably designed as a passenger display via short, repeated glances, and thus from being able to be distracted from traffic events, the fade-out rate is increased in an advantageous manner as soon as the gaze is directed at the output device again during or after a fade-in process in the pre-determined interval of time. The driver is thus prompted to turn their gaze away from the output device and permanently back towards the traffic events.

The term “image data” is presently understood broadly. It comprises the output of alphanumerical signs, graphics, images, video images, television images, internet content, vehicle data, navigation data of the vehicle etc. The optically output image data advantageously comprises video content, internet content and/or photo content and/or navigation data and/or other data for guiding the vehicle and/or for controlling systems of the vehicle.

The term “output device” for the optical output of image data is presently understood broadly. In principle, the output device comprises all devices known today for optical output of image data, e.g.: FED, LCD, TFT, LCD, CRT, plasma, OLED or SED displays, touch screens, and LED systems, laser projection systems, in particular HUDs (head-UP displays).

The term “vehicle” is presently understood broadly. In particular, it comprises land vehicles (motor vehicles, buses, HGVs etc.), air vehicles, water vehicles, underwater vehicles, rail vehicles.

The term “gaze direction” of the driver presently describes the direction in which the driver is currently looking with their eyes. The gaze direction can be determined by different methods, for example by eye tracking recording corneal reflection or by derivation from a head alignment.

The term “fade out” presently describes the, in particular, gradual or progressive reduction of perceptibility of image data optically displayed on the output device. The process of fading out preferably runs over a pre-determined period of time >0, and, after it has run without being disturbed, leads to no more image data being visible by a person on the output device.

The terms “average fade-out rate, DOWN” and “average fade-out rate, DOWN1” describe the reduction of the perceptibility of the optically displayed image data averaged over time from the beginning to the end of the fade-out, i.e., the average fade-out gradient of DOWN 1 is larger than that of DOWN. The average fade-out rate can preferably be described by a gradient of the respective degree of fade-out from the beginning to the end of the fade-out. It is assumed here that image data can be faded out starting from a perceptibility of 100%, but also from a lower level. The fade-out is implemented, for example, by a pixel resolution, a discrimination, and/or a brightness of the screen display being entirely or partially reduced.

The term “fade in” presently describes the in particular gradual or progressive increase or improvement of perceptibility of image data optically displayed on the output device.

The term “average fade-in rate UP” describes the averaged increase/improvement of the perceptibility of the optically displayed image data over time. The average fade-in rate can preferably be described by a gradient of the reducing degree of fade-out from the beginning to the end of the fade-in.

The fade-out is implemented at the increased averaged fade-out rate DOWN1 as soon as the gaze is directed back to the output unit after being turned away for a pre-determined duration lying within the interval. In a preferred embodiment, the interval of time lies between the point in time at which the image data has reached a degree of fade-out of 0% and a pre-determined later point in time in relation to this point in time.

In an advantageous embodiment of the method, in the event of the gaze being turned away from the output device, an imaginary fade-in function lagging behind the fade-in rate UP is generated by decrementing the current level of the fade-out rate. The increased fade-out rate DOWN1 is caused, in the event of the gaze being turned towards the output device before complete decrementation, by jumping to the degree of fade-out of the imaginary function at the moment of the gaze turning towards the output device.

By means of the imaginary function, a current brightness value is preferably gradually decremented in stages. The imaginary function differs in relation to the real, much faster fade-in rate UP by slowly reducing the degree of fade-out, such that the degree of fade-out of 0% is reached at a later point in time in relation to the real fade-in rate UP, and the imaginary fade-in function lags behind the fade-in rate UP. This point in time is determined by the number of stages, the height and length of the stages of the imaginary function. By reducing the stage length, a linear function can also be digitally approximated to an extent. In the period of time from the start to the maximum decrementation of the imaginary fade-in function, when the gaze is turned towards the output device, a jump is made to the degree of fade-out of the imaginary function at the moment the gaze is turned towards the output device. In other words, the earlier the user looks at the output device again after a real, complete fade-in of the image data, the sooner the optical perceptibility of the image data is reduced again.

In a development of the suggested method, the fade-in of image data comprising moving images (videos, films) is only carried out if the audio output assigned to the output unit is connected to head- or earphones, and the audio signals are only output via these head- or earphones. When the head- or earphones are disconnected from the output unit, the image is faded out regardless of the gaze direction of the driver. This means that the moving images are only shown if the driver does not direct their gaze to the output unit and the audio signals of the output unit are output via headphones or earphones. In addition to avoiding the driver being distracted by looking at the output unit, the sound signals that usually accompany moving pictures lead to the driver being further distracted, in particular, the interest of the driver in the content of the output unit is awoken by the sound signals. So that maximum concentration on traffic events can be guaranteed, the driver is advantageously kept free of distraction by moving images and associated sound signals. In other words, it is only possible for the front-seat passenger to see the video if the audio output, preferably assigned to the front passenger seat, of the output device is connected to head- or earphones and the driver simultaneously does not direct their gaze to the output unit.

In a particularly advantageous development of the suggested method, beyond a pre-determined steering angle or a pre-determined steering angle speed, the fade-out does not increase, even if the gaze direction is directed at the output device. At the pre-determined steering angle assigned to a driving maneuver, the driver inevitably also turns their gaze direction and head direction in the direction of the output device to follow the traffic events in the direction of travel. As it can be assumed that in such a driving situation on a bend, the driver directs their gaze direction and head direction substantially in the direction of the output device, but follows the course of the road, no increase in fade-out is implemented for the front-seat passenger in this situation to ensure maximum availability of the image data. In other words, starting from image data with maximum perceptibility, no new fade-out process is started, and if a fade-out process is in progress, no further fade-out takes place, and instead the level previously reached is preferably maintained.

In a particularly advantageous development of the suggested method, the fade-out does not increase if the camera for recognizing gaze detection by eye tracking is covered by the steering wheel in a pre-determined steering angle region. The camera is usually arranged behind the steering wheel in a region in the gaze direction of the driver, such that when the steering wheel turns at a particular angle of rotation, the recording region of the camera is covered by the steering wheel spokes. As soon as such covering occurs, a gaze direction at the output unit cannot be recognized. As the covering caused by a steering wheel is usually only briefly present in the driving operation, for the sake of the accessibility of the output unit being as high as possible, no increase in fade-out takes place for a front-seat passenger. The suppression of the increase of the fade-out is implemented in a temporally limited manner in this case. To prevent the camera from being improperly covered, the fade-out is continued after a pre-determined period of time. In other words, the current state of the perceptibility of the image data displayed on the output unit is preferably maintained when it is recognized that the camera for eye-tracking is covered.

In a preferred embodiment, as soon as the vehicle is in a pre-determined geo-position, no fade-out takes place. Geographic regions in which a fade-out represents an unnecessary limitation of the availability for a front-seat passenger can be defined in an advantageous manner. For example, a fade-out can thus be suppressed on parking premises, on business premises, in areas that only allow a low driving speed, at crossings or crossroads, as either the demands on driving activity are low or the driver is forced to direct their gaze to traffic events, and not to a front-seat passenger display.

In a preferred alternative or additional embodiment, the gaze direction is determined from a head position of the driver. It can be determined from the head position whether the driver is directing their gaze in the direction of the output device, in particular in the direction of the front-seat passenger display. The evaluation of the head position is used to carry out a plausibility test on a gaze direction determined via eye tracking. In particular, the gaze direction determined via the head position is used as soon as a determination via eye tracking is no longer possible, for example due to mirrored sunglasses. Due to the lower precision of the gaze direction determination on the basis of head position compared to eye tracking, the parameters determining the fade-out and fade-in rate, the time delay for fading out and fading in are preferably adjusted such that the perceptibility of the content of the output unit decreases more quickly and increases more slowly. In other words, the fade-out rate is increased, the fade-in rate is slowed and/or the time delay for fading out and fading in is reduced or increased after it is recognized that the gaze is being turned towards or away from the output device, respectively.

In an advantageous embodiment, the fade-ins and fade-outs are carried out dependent on context. For example, only one region that comprises the display of moving images is faded out. The videos or changing internet content associated with increased distraction for the driver can thus be faded out, and predominantly static displays such as addresses, maps, or vehicle settings can be displayed unchanged.

A further aspect of the invention relates to a system with which image data can be optically output in a vehicle on an output device. The system comprises a sensor system arranged in the vehicle that is designed and equipped to determine a gaze direction of a driver of the vehicle, a control unit of the output device that is designed and equipped such that if the determined gaze direction is directed at the output device, the optical output of the image data is faded out at an average fade-out rate DOWN, wherein the fade-out rate DOWN defines a decrease of the optical perceptibility of the output image data over time, and if the determined gaze direction is directed at the output device and is directed away from the output device, the optical output of the image data is faded in at an average fade-in rate UP, wherein the fade-in rate UP describes an increase of the optical perceptibility of the output image data over time, wherein the control unit carries out the fade-out at an increased average fade-out rate DOWN1 in relation to the fade-out rate DOWN if the driver directs their gaze direction to the output device again within a pre-determined interval of time in relation to the start of the fade-in process.

A last aspect of the invention relates to a vehicle having a system as previously described.

Further advantages, features and details result from the following description in which—optionally with reference to the drawings—at least one exemplary embodiment is described in detail. Identical, similar and/or functionally identical parts are provided with the same reference numerals.

### BRIEF DESCRIPTION OF THE DRAWING FIGURES

Here:

FIG. 1 shows a very schematic course of a method according to the invention,

FIG. 2 shows an example of a change of the perceptibility of the emitted image data, wherein the user looks at the output device at a point in time and does not turn their gaze away,

FIG. 3 shows an example of a change of the perceptibility of the output image data, wherein the user looks at the output device at a point in time and turns their gaze away from the output device again,

FIG. 4 shows an example of the change of the perceptibility of the output image data with imaginary fade-in steps, wherein the user turns their gaze away from the output device,

FIG. 5 shows an example of the change of the perceptibility of the output image data with imaginary fade-in steps, wherein the user turns their gaze away from the output device and turns their gaze towards the output device again at a later point in time and

FIG. 6 shows a further example of the change of the perceptibility of the output image data with imaginary fade-in steps, wherein the user later turns their gaze towards the output device again in relation to FIG. 6 and

FIG. 7 shows a schematically depicted vehicle interior having a front-seat passenger display.

### DETAILED DESCRIPTION

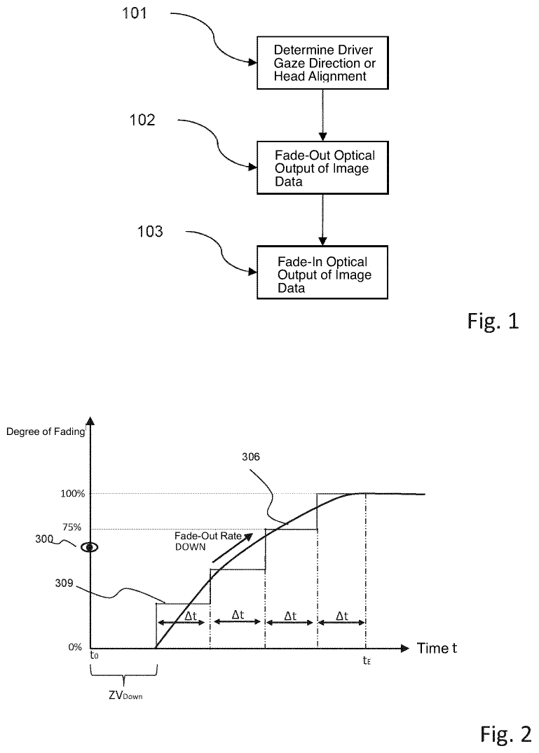

FIG. 1 shows a very schematic course of a method according to the invention for influencing an optical output of image data on an output device in a vehicle, having the following steps. In a step 101, a gaze direction or head alignment of a driver of the vehicle is determined with a sensor system in the vehicle. In a step 102, if the determined gaze direction is directed at the output device, the optical output of the image data is faded out at an average fade-out rate DOWN, i.e., an increase of the degree of fade-out, wherein the fade-out rate DOWN defines a decrease of the optical perceptibility of the output image data by a person over time. In a step 103, if the determined gaze direction is directed at the output device in step 102 and is then directed away from the output device, the optical output of the image data is faded in at an average fade-in rate UP, i.e., a decrease of the degree of fade-out, wherein the fade-in rate UP describes an increase of the optical perceptibility of the output image data by a person over time.

FIG. 2 shows an example of a change of the perceptibility of the output image data, wherein the driver looks at the output device at a point in time t₀ and does not turn their gaze away for a relatively long time, e.g., 10 s.

In the depicted diagram, the time t is specified in percent [%] along the x axis and the degree of fade-out of the image data displayed on the output device is specified in percent [%] along the y axis. The degree of fade-out of 0% presently corresponds to an optimal output of image data for the output device. At a degree of fade out of 100%, image data to be output cannot be perceived by a person.

As already previously described, the degree of fade out, i.e., the perceptibility can, for example, be changed by: changing the image brightness of the image data to be output on the output device and/or by changing the blurring of the image data to be output. The degree of fade-out of 100% thus corresponds, for example, to a “black” screen in the case of which the image brightness of the image data to be output is equal to zero, or it corresponds, for example, to a blurring of the output image data that does not allow the image data to be output to be recognized.

In the depicted graphic, the course of the fade-out of the image data to be output is depicted in a case where the image data to be output is first depicted on the output device at a degree of fade-out of 0%, i.e., a perceptibility of 100%, and at time t₀ it is determined that, as shown by the eye symbol 300, the driver turns their gaze to the output device.

The fade-out 102 of the optical output of the image data to be output at an average fade-out rate DOWN, however, does not begin at the time t₀, but with a time delay ZV_{DOWN}, which is, for example, 2, 3 or 4 seconds long. The fade-out 102 of the optical output of the image data at the average fade-out rate DOWN is implemented corresponding to a heuristically determined fade-out function 306. In other words, the fade-out corresponding to the fade-out function 306 causes the average fade-out rate DOWN perceived by the driver.

An imaginary step function 309 is determined by computation, wherein the incremented step function 309 reaches the degree of fade-out of the fade-out function 306 equally quickly, i.e., within the same period of time, in the present example at the point in time t_{E}. The imaginary fade-out function 309 is presently designed with equidistant support points at a spacing of Δt.

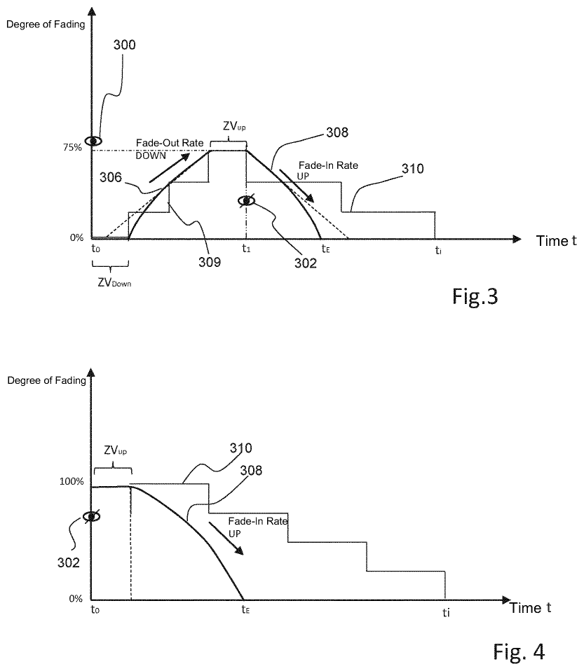

FIG. 3 shows an example of a change of the perceptibility of the output image data, wherein the driver first looks, at time t₀, at the output device, as depicted by the eye symbol 300, and turns their gaze away from the output device again at the point in time t₁, depicted by the crossed-out eye symbol 302. In the example shown, the time difference between t₀ and t₁ is too low for the degree of fade-out of 100% to be able to be reached. At the point in time t₁, the degree of fade-out of the output image data is: 75%.

The fade-out, i.e., the increase of the degree of fade-out corresponding to the degree of fade-out DOWN is implemented with the fade-out function 306 corresponding to FIG. 2.

The fade-in 103, i.e., a reduction of the degree of fade-out of the optical output of the image data is implemented with a time delay ZV_{UP}, for example of 2 seconds, and at an average fade-in rate UP corresponding to the fade-in function 308, i.e., the reduction of the degree of fade-out of the optical output of the image data is presently implemented corresponding to the fade-in function 308. In an exemplary embodiment not depicted: UP>DOWN, i.e., the reduction in the degree of fade-out is slower than the increase, i.e., the increase of the perceptibility is slower than the reduction.

The imaginary fade-out function 309 follows the fade-out function 306 in stages, an imaginary fade-in function 310 reaches the degree of fade out of 0% with a significant time delay compared to the fade-in function 308. Due to the lower fade-in rate of the imaginary fade-in function 310 compared to the real fade-in function 308, i.e., at least lower average increase, the degree of fade-out of 0% is thus reached at a later point in time ti compared to t_{E} in relation to the fade-in function 308.

FIG. 4 shows an example of a change of the perceptibility of the output image data, wherein the driver looks away from the output device at a point in time t₀, as depicted by the crossed-out eye symbol 302. A reduction of the degree of fade-out is implemented with a time delay ZV_{UP}. An increase of the perceptibility of the real image data perceived by the user is caused by the fade-in function 308, such that the average fade-in rate UP is adjusted. Simultaneously, when the time delay ZV_{UP} runs out, the imaginary function 310 is generated by decrementing from the current level of the degree of fade-out. The imaginary fade-in function 310 reaches a degree of fade-out of 0% at a later point in time ti>t_{E} compared to the fade-out function 308, i.e., the imaginary function runs with a time delay or lag in relation to the fade-in rate UP.

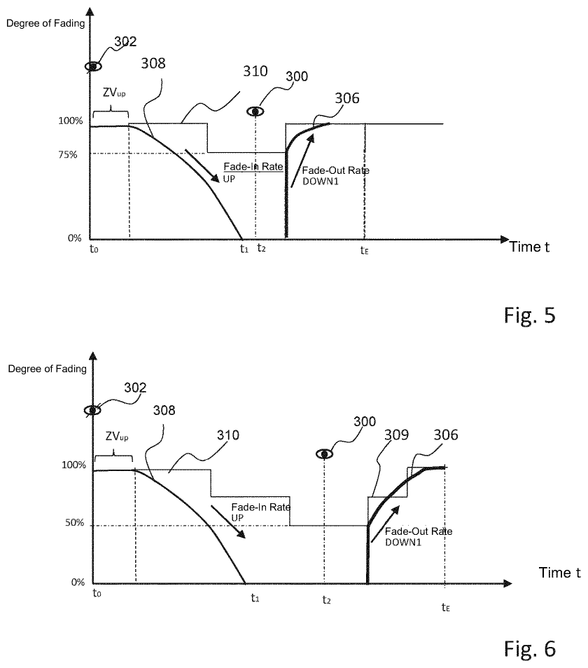

FIG. 5, corresponding to FIG. 4, shows a driver who looks away from the output device at a point in time t₀. Unlike FIG. 4, in FIG. 5 the driver turns their gaze to the output device again at a point in time t₂, in a window of time where the fade-in function 308 has reached the degree of fade-out 0% at the point in time t₁, i.e., the image data is completely visible again, and where the imaginary function 310 has not yet been fully decremented, i.e., has not yet reached the degree of fade-out 0%. To punish the driver as it were, the degree of fade-out is not continuously boosted from 0% again as in FIG. 2, and instead the degree of fade-out jumps to the degree of fade-out of the imaginary fade-out function 10 at the moment that the gaze turns towards the output device, i.e., the degree of fade-out is abruptly increased to 75%, and further from this level according to the fade-out function 306 known from FIGS. 2 to 4, from the level of 75% to 100% degree of fade-out. The average fade-out rate DOWN1 results from the jump to the level of the imaginary fade-out function 310. In comparison with FIG. 2, the driver perceives a very fast real reduction of the perceptibility of the image data 360 up to the degree of fade-out of 100% at a fade-out rate DOWN1.

In FIG. 6, in comparison with FIG. 5, the driver turns their gaze towards the output device at the point in time t2, later compared to t1, i.e., to the point in time at which the fade-in function 308 reaches the degree of fade-out 0%. The imaginary function 310 has already decremented to a lower level in relation to FIG. 5, and accordingly the degree of fade-out jumps to a level of 50%. The imaginary fade-out function 309 follows the fade-out function 306 in stages following the jump according to the comments made with reference to FIG. 2. The later the driver turns their gaze back to the output unit after complete visibility of the image data, the more the average fade-out rate DOWN1 flattens, i.e., the lesser the punishment by fading out more quickly.

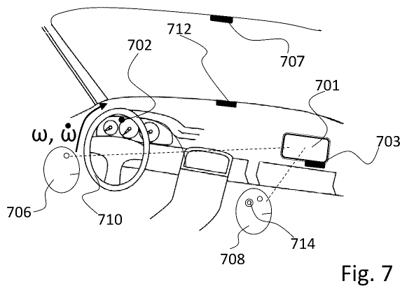

FIG. 7 shows a vehicle cockpit with a schematically depicted driver 706 and front-seat passenger 708. The vehicle has a sensor device designed as a camera 702 to determine the gaze direction of the driver from an eye position and a further camera 707 for determining the head alignment of the driver. An output device designed as a front-seat passenger display 701 for depicting display content intended for the front-seat passenger 708 is arranged on the front-seat passenger side, wherein the display content and the degree of fade-out are controlled by a control device 703. The steering wheel 710 is assigned a steering angle sensor (not depicted) which determines a steering angle location ω and a steering angle speed \dot{ω}. A GPS receiver 712 determines the geo-data of the current parking location of the vehicle. The front-seat passenger 708 wears headphones 714 for example connected to an audio output device of the passenger display 701 via bluetooth.

To guarantee the highest possible availability of the front-seat passenger display 701 for the front-seat passenger 708, and the lowest possible distraction for the driver 706, (videos, films) with a degree of fade-out of 0% are only shown if the audio signals are only output via the headphones 714. The control device 703 further monitors the steering angle and the steering angle speed. Beyond a pre-determined steering angle and/or steering angle speed, the front-seat passenger screen 701 is not faded out, as it is assumed that the driver 706 is busy with the steering task, which requires a concentrated gaze on the road. The control device further knows that beyond a particular steering angle, the camera 702 is covered by the spokes of the steering wheel 710. In the event of covering by spokes, a fade-out of the image data is likewise not required, unless the further camera 712 determines from the head position of the driver 706 that they are looking towards the front-seat passenger display 701. Determining the gaze direction from the head position is available in addition or as an alternative to determining the gaze direction from the eye position, for example when the camera 702 is covered or if the driver is wearing sunglasses. As determining the gaze direction from the head alignment is less reliable and precise, the time delay ZV_{UP} and ZV_{DOWN} is increased, for example, and/or the fade-in and fade-out rate UP and DOWN are increased.

The control device further monitors the geo-data transmitted from the GPS receiver. The location of the vehicle is determined with reference to the geo-data, and the control device 703 controls the degree of fade-out and the fade-out rate and fade-in rate of the front-seat passenger display depending on the location. The control device further controls the degree of fade-out and the fade-out rate and fade-in rate of the front-seat passenger display depending on the display content, i.e., the context of the moving images, i.e., content that is connected to the driving task is not or at least more slowly faded out on the front-seat passenger display 701 in the event of a gaze of the driver 706 in comparison with pure entertainment content, e.g., films. Moving images connected to the driving task are, for example, navigation maps, images of the environment augmented with additional information or driving instructions.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for influencing output of optically displayed image data on an output device in a vehicle, the method comprising:
determining a gaze direction of a driver of the vehicle in the vehicle,
fading-out, responsive to the determined gaze direction being directed at the output device, the optically displayed image data at an average fade-out rate DOWN, wherein the fade-out rate DOWN gradually reduces of visibility of the optically displayed image data averaged over time, wherein the output device is a front-seat passenger display; and
fading-in, responsive to the determined gaze direction being directed at the output device and then being directed away from the input device, the optically displayed image data at an average fade-in rate UP, wherein the fade-in rate UP gradually increases visibility of the optically displayed image data averaged over time,
wherein, when, within a pre-determined interval of time relative to a start of the fading-in, the determined gaze direction is directed again at the output device, the optically displayed image data is faded-out at an increased average fade-out rate DOWN1 relative to the average fade-out rate DOWN, and
wherein, when the determined gaze direction is away from the output device, an imaginary fade-in function lagging behind a fade-in function having the fade-in rate UP with a time delay is generated by decrementing a current level of a degree of fade-out, and
wherein the increased average fade-out rate DOWN1 is caused, responsive to the determined gaze being turned towards the output device before a point in time at which the imaginary fade-in function is decremented to a degree of fade-out of 0%, by jumping to the degree of fad-out of the imaginary fade-out function when the determined gaze is at the output device.

12. The method of claim 11, wherein, when the optically displayed image data comprises moving images, the fading-in of the optically displayed image data is only performed when an audio output assigned to the output unit is connected to headphones or earphones, and audio signals are only emitted via the headphones or earphones.

13. The method of claim 11, wherein the fading out does not increase when a steering angle exceeds a predetermined steering angle or a steering angle speed exceeds a predetermined steering angle speed.

14. The method of claim 11, wherein the fading-out does not increase as soon as a camera of the vehicle is covered by a portion of a steering wheel of the vehicle.

15. The method of claim 11, wherein when the vehicle is in a pre-determined geo-position, the fading-out does not occur.

16. The method of claim 11, wherein the gaze direction of the driver is determined from a head position of the driver.

17. The method of claim 16, wherein the fade-in and fade-out rate or a point in time of activation of the fading-in or fading-out differs when the gaze direction is determined based on the head position of the driver compared to recognition of the gaze direction of the driver by eye tracking.

18. The method of claim 11, wherein the fading-in and fading-out is performed dependent on context.

19. A system for influencing output of optically displayed image data on an output device in a vehicle, the system comprising:
a sensor system arranged in the vehicle and configured to a gaze direction of a driver of the vehicle; and
a control unit coupled to the sensor system and configured to control the output device by
fading-out, responsive to the determined gaze direction being directed at the output device, the optically displayed image data at an average fade-out rate DOWN, wherein the fade-out rate DOWN gradually reduces of visibility of the optically displayed image data averaged over time, wherein the output device is a front-seat passenger display; and
fading-in, responsive to the determined gaze direction being directed at the output device and then being directed away from the input device, the optically displayed image data at an average fade-in rate UP, wherein the fade-in rate UP gradually increases visibility of the optically displayed image data averaged over time,
wherein, when, within a pre-determined interval of time relative to a start of the fading-in, the determined gaze direction is directed again at the output device, the optically displayed image data is faded-out at an increased average fade-out rate DOWN1 relative to the average fade-out rate DOWN, and
wherein, when the determined gaze direction is away from the output device, an imaginary fade-in function lagging behind a fade-in function having the fade-in rate UP with a time delay is generated by decrementing a current level of a degree of fade-out, and
wherein the increased average fade-out rate DOWN1 is caused, responsive to the determined gaze being turned towards the output device before a point in time at which the imaginary fade-in function is decremented to a degree of fade-out of 0%, by jumping to the degree of fad-out of the imaginary fade-out function when the determined gaze is at the output device.
